(19) United States
(12) Patent Application Publication
(10) Pub. No.: US 2002/0103753 A1
(43) Pub. Date: Aug. 1, 2002

(54) Charge splitter application

(76) Inventor: Michael Schimmel, Chicago, IL (US)

Correspondence Address: LOTT & FRIEDLAND, P.A., P.O. BOX 141098, CORAL GABLES, FL, 33114-1098, US

(21) Appl. No.: 09/774,835

(22) Filed: Jan. 31, 2001

(51) Int. Cl. G06F 17/60

(52) U.S. Cl. 705/39

(57) ABSTRACT

Systems and methods for splitting the costs of goods and services among multiple payment sources without undue burden to the consumer or vendor. The system can be practiced in either a centralized format or a distributed format. The invention can also function offline, in an alternate embodiment.

### FIELD OF INVENTION

The present invention relates generally to facilitating financial transactions, and more specifically, to providing a system and method for splitting the costs of goods and services among multiple payment sources without undue burden to the consumer or vendor.

### BACKGROUND OF THE INVENTION

Online commerce is expanding at an unparalleled rate. Recent e-commerce statistics include:

online retail sales estimated at $66 billion for 1999

96.7% of online consumers plan to buy online again

1999 online holiday sales hit $7 billion (customers who shopped between Nov. 1 and Dec. 31, 1999)

13% of Americans used the Internet to buy holiday gifts, and online purchases averaged $314 each

retail spending from America Online's (AOL) members totaled $2.5 billion for the period between Thanksgiving and Christmas, double that of 1998. This figure contributes to a 1999 total of $10 billion for AOL members online purchasing. Roughly two-thirds of AOL's members (13.2 million of 20 million) shopped for the holidays.

The Internet has become a preferred medium for communication and commerce worldwide. The Internet connects more than 56 million host computers in 247 countries. The Internet is now growing at a rate of about 40% to 50% annually (for machines physically connected to the Internet), according to data from the Internet Domain Survey, the longest-running survey of Internet hosts. Such exponential growth has led to the expansion of the Internet from 562 connected host computers in 1983 to 56.2 million such computers in July 1999. At any time from 1983 through 1996, half of the Internet's historical growth had occurred in the preceding 12 to 14 months. In 1997, the editor of Wired magazine argued that “the Internet is actually being underhyped. Of all the people [who will be online] in 10 years, only a tenth are online today.”

Various research and consulting firms have estimated the number of U.S. users to be 83 million to 92 million in 1999. There are other estimates of 102 million in North America to 179 million worldwide. These figures do not include military computers, which for security reasons are invisible to other users. Many hosts support multiple users, and hosts in some organizations support hundreds or thousands of users.

Two surveys in December 1999 reported increases in the number of Internet users in the United States. According to a Harris Poll, the number has soared from 9% of adults in 1995 to 56% in 1999. The number of U.S. Internet users has increased 600% in the past 4 years. Harris also found that 81% of computer users access the Internet from home, the office, school, or a library, compared to 18% in 1995. Zona Research, in a survey conducted in the third quarter of 1999, estimated that 90 million U.S. adults are Internet users, compared with 85.3 million adults who are not. It is the first time that Zona's Worldwide Internet Tracking Study has shown more Internet users than non-users.

According to the Computer Industry Almanac, Inc., the United States has an overwhelming lead in Internet users with over 50% of an estimated total 150 million Internet users worldwide at the end of 1998; but, the United States is only ranked fifth in Internet users per capita. The Nordic countries (Finland, Iceland, Norway, and Sweden) are the leaders with 29% or more of the population being regular Internet users.

These statistics point to ever-increasing usage of the Internet for the general consumer and therefore more online purchases of goods and services can be expected. These sales transactions must be consummated in a quick and convenient manner in order for e-commerce to become as prevalent as traditional methods of purchasing.

Since the birth of e-commerce, several online payment services have emerged. By 2001, 80 percent of commerce-enabled Internet sites in the United States will have online connections to credit card processing networks (GartnerGroup, June 1999). These service providers have created a virtual link between the Merchant web site and the card-processing networks. This link allows for the secure transmission of payments through the public Internet. Once integrated into a merchant site, they allow the online merchant to verify and authorize payments real-time during the customer's online payment process. An online business can plug this software directly into its Merchant site, or access it as a module in a larger E-commerce package available from E-Commerce application vendors (discussed later). While these services and other payment systems have attempted to facilitate online purchasing, they do not provide for conveniently splitting the cost of a transaction among multiple payment sources.

In addition to expansion of retail commerce online, traditional offline retail sales continue to flourish. Take as an example the retail apparel industry. Apparel sales in the United States rose moderately in 1999, to $184 billion, according to recently released data from The NPD Group, Inc. There was a 4 percent increase in both dollar and unit volume in 1999. However, brick-and-mortar (offline) retailers continued to dominate the market, capturing almost nine out of ten dollars spent on apparel (almost $163 B). These numbers are fairly representative of the retail industry as a whole, highlighting the importance of seamless and convenient methods of payment for purchases.

Previous attempts have been made to provide a method and system for splitting charges such as described in U.S. Pat. No. 6,128,601 to Van Horne et al. (the '601 patent); U.S. Pat. No. 6,119,105 to Williams (the '105 patent); U.S. Pat. No. 6,111,522 to Hiltz et al. (the '522 patent); U.S. Pat. No. 6,061,665 to Bahreman (the '665 patent); U.S. Pat. No. 6,047,269 to Biffar (the '269 patent); U.S. Pat. No. 6,047,268 to Bartoli et al. (the '268 patent); U.S. Pat. No. 6,035,281 to Crosskey et al. (the '281 patent); U.S. Pat. No. 5,974,146 to Randle et al. (the '146 patent); U.S. Pat. No. 5,826,241 to Stein et al. (the '241 patent); U.S. Pat. No. 5,757,917 to Rose et al. (the '917 patent); U.S. Pat. No. 5,649,118 to Carlisle (the '118 patent); U.S. Pat. No. 5,590,197 to Chen et al. (the '197 patent); U.S. Pat. No. 5,513,102 to Auriemma (the '102 patent); all of which are incorporate herein by reference.

The '601 patent describes a system and method for remotely connecting client computers to a communication network such as the Internet by way of a server system handling a plurality of client computers and having the capability of dynamically providing network connections to the client computers, separately billing usage time and tracking usage and preferably updating access software on the Client computers. A hot access port is provided for client system access in which a welcome signal is pushed from the server system to the access port. After a connection is made between the client system and the access port, the client system receives the welcome signal.

The '105 patent describes how secure transmission of data is provided between a plurality of computer systems over a public communication system, such as the Internet. Secure transmission of data is provided from a customer computer system to a merchant computer system, and for the further secure transmission of payment information regarding a payment instrument from the merchant computer system to a payment gateway computer system. The payment gateway system evaluates the payment information and returns a level of authorization of credit via a secure transmission to the merchant which is communicated to the customer by the merchant. The merchant can then determine whether to accept the payment instrument tendered or deny credit and require another payment instrument. An architecture that provides support for additional message types that are not SET compliant is provided by a preferred embodiment of the invention. A server communicating bidirectionally with a gateway is disclosed. The server communicates to the gateway over a first communication link, over which all service requests are initiated by the server. The gateway uses a second communication link to send service signals to the server. In response to the service signals, the server initiates transactions to the gateway or presents information on a display device.

The '522 patent describes a dual processor electronic parking meter (EPM) that accepts a plurality of ISO compliant smart cards and authorizes payment of purchased time. The EPM of the invention is equipped with a card reader module (CRM) which accepts/validates transactions effected on smart cards, and also accepts a interface card for connection to a data terminal for revenue collection, meter configuration and meter firmware maintenance. The EPM includes a multi-lingual, intelligent, mixed-mode graphics and icon based display with greater visibility. When the EPM is idle, various sections of the meter are in a sleep mode for prolonging the life of the batteries. The EPM wakes up whenever a card is in the CRM, a coin is inserted, or a key for selecting the parking time and the type of operation is actuated. The EPM is easy to use by both the parking time purchaser and the money collector. The EPM contains a large memory and can be reprogrammed in the field to support new cards, different user languages, and system parameters such as rate, off time, or minimum purchased time. It is off-the-shelf solution provided with protection circuitry and designed to be used in unattended locations.

The '665 patent describes a system that facilitates the coupling of a plurality of clients to one or more merchants utilizing a network to conduct commerce over the network is disclosed. When a client initiates a connection with a merchant, the merchant responds to the request for connection by transmitting one or more messages back to the client to determine a particular payment processing which entails determining a suitable payment instrument, a payment protocol and standard message formats for conducting the electronic commerce. The payment protocol comprises a message format, a protocol associated with the message format and a weight associated with each of the items associated with the payment processing. The weight is provided by both the client and the merchant to facilitate dynamic negotiation of a mutually acceptable payment processing. The negotiation results in the exchange of standard message formats that the client and the merchant are equipped to process efficiently and securely.

The '269 patent describes how a self-contained payment system uses circulating digital vouchers for the transfer of value. The system creates and transfers digital vouchers. A digital voucher has an identifying element and a dynamic log. The identifying element includes information such as the transferable value, a serial number and a digital signature. The dynamic log records the movement of the voucher through the system and accordingly grows over time. This allows the system operator to not only reconcile the vouchers before redeeming them, but also to recreate the history of movement of a voucher should an irregularity like a duplicate voucher be detected. These vouchers are used within a self-contained system including a large number of remote devices which are linked to a central system. The central system can be linked to an external system. The external system, as well as the remote devices, are connected to the central system by any one or a combination of networks. The networks must be able to transport digital information, for example the Internet, cellular networks, telecommunication networks, cable networks or proprietary networks. Vouchers can also be transferred from one remote device to another remote device. These remote devices can communicate through a number of methods with each other. For example, for a non-face-to-face transaction the Internet is a choice, for a face-to-face or close proximity transaction, tone signals or light signals are likely methods. In addition, at the time of a transaction a digital receipt can be created which will facilitate a fast replacement of vouchers stored in a lost remote device.

The '268 patent describes a method and apparatus for authenticating transactions accomplished over a data network utilizes a “cookie” containing both static information (user-identifying information) and dynamic information (transaction-based information). The transaction-oriented dynamic information portion comprises a random number and a sequence number, the latter tracking the number of billing transactions conducted by the user associated with the account number. The cookie, sent to the user's cookie file upon a previous transaction, is valid for only a single new transaction. A billing server, upon receiving the cookie containing the static and dynamic information portions, identifies the user from the account number in the static portion and accesses from an associated database the expected random number and sequence number that the billing server last sent to that user in the transaction-oriented dynamic portion. If the expected dynamic portion matches the received dynamic portion, the user is authenticated to proceed with the current transaction

The '281 patent describes a system and method for billing one or more participating parties for client access to the internet is disclosed including the steps of identifying at least one of the one or more participating parties as being responsible for the billing, allocating a share of the billing to each responsible participating party based on a predetermined function and computing a billing amount for each of the responsible participating parties based on a function of the share and a client bandwidth usage.

The '146 patent describes an infrastructure for a real time bank-centric universal payment system in which a central processing unit (CPU) defines an electronic commerce trust system formed from a plurality of financial service provider members subscribing to a common standard having applicability throughout the infrastructure. The central processing unit is operatively interconnected to the correspondent processing units of financial service provider members that in turn are operatively interconnected through access mechanisms to a network of customers and goods and services providers who are account subscribers with the financial service provider member and subject to the common standard of the system. The CPU provides non-revocable real time debit and credit transactions and effects provider net settlement between and among members through a central exchange monetary system. Features of the infrastructure include an ECTS hot file, bill presentment and payment options and provider designed services that enhance brand identity.

The '241 patent describes a payment system for enabling a first Internet user to make a payment to a second Internet user, typically for the purchase of an information product deliverable over the Internet. The payment system provides cardholder accounts for the first and second Internet users. When the second user sends the information product to the first user over the Internet, the second user also makes a request over the Internet to a front end portion of the payment system requesting payment from the first user. The front end portion of the payment system queries the first user over the Internet whether to proceed with payment to the second user. If the first user replies affirmatively, a charge to the first user is processed off the Internet, however if the first user replies negatively, the first user is not charged for the information product. The payment system informs the second user regarding whether the first user's decision and pays the second user upon collection of the charge from the first user. Security is maintained by isolating financial and credit information of users' cardholder accounts from the front end portion of the payment system and by isolating the account identifying information from the associated e-mail address.

The '917 patent describes a method and system for use on a quasi-public network such as the Internet to enable users of the network to conduct commercial transactions involving a payment of funds by one user to another user of the network. The method includes operating a computer system for sending and receiving messages from users over the network. Upon receiving a message over the network from a qualified user-seller, a message is sent over the network to the user-buyer that was identified in the message from the user-seller. The message to the user-buyer requests confirmation of a transaction identified in the message received from the user-seller. Upon receiving a confirmation over the network from the user-buyer, payment information is sent by secure channels off the network to an agent of the user-seller. The user-seller's agent may be a separate entity or the function of the user-seller's agent may be performed by the transaction enabling system. Upon receipt of an authorization code from the seller's agent, the authorization code is encrypted and sent to the user-seller over the network.

The '118 patent describes systems and methods wherein a single set of consumer items may be purchased by debiting any of a plurality of accounts stored on a smart card. According to an embodiment disclosed herein, a point-of-sale terminal includes a terminal processor, an item identification device, a terminal memory, and a smart card reader. The item identification device may include a conventional UPC bar code reader adapted to read UPC bar codes on consumer items. A cost table and a plurality of item tables are electronically stored in terminal memory. The cost table associates each item identifier (UPC bar code) with a corresponding cost. Each item table contains a list of item identifiers, and may optionally associate specific item identifiers with corresponding accounts. Each item table is uniquely identified using an item table identifier. The terminal memory, item identification device, and smart card reader are all coupled to the terminal processor. A smart card is equipped with a smart card memory for storing a plurality of data files, and a smart card processor adapted to execute a software operating system for managing the plurality of data files. Each data file associates an account identifier for uniquely specifying a given account with an account balance and at least one item table identifier. Accounts are implemented, for example, by service providers such as Visa, MasterCard, Discover, ATM networks, food stamp programs, other types of welfare programs, unemployment compensation, or the like.

The '197 patent describes a cyber wallet in the form of stored and protected account information, which may be “carried” on a tamper resistant portable electronic storage medium such as a smartcard, or stored on the customer's computer (or personal digital assistant PCMCIA card, or the like) together with the browser/mosaic software, is provide to a customer for the purpose of making electronic payments from the possessor of the wallet to a merchant at a remote site on the Internet. Security of the information contained in the wallet is provided by a public key file containing public keys to be used for encrypting the payment information into an authorization ticket which is sent by the wallet to the merchant, and then forwarded to the account servicer for decryption, the decryption key being in the form or a private key held only by the account servicer, and to which the merchant and other parties have no access. The public key file preferably contains a plurality or public keys selectable by an identifier associated with but not a part of the key itself, so that the account servicer can control, by having the merchant send an identifier to the wallet, the selection of uncompromised keys without anyone but the servicer having knowledge of which key is being selected.

The '102 patent describes data processing methods for enhancing the value of a substantially conventional credit card so as to enhance a user's perception of the desirability of holding and using the card and encourage increased use of the card for its normal utility as a payment device. The user cams, for each transaction amount or payment amount of at least a predetermined size, a coupon redeemable by the user for a lottery ticket by which the user has an opportunity to recover at least a portion and potentially in excess of the user's transaction-based expenditures or payments. Transaction amounts or payment amounts in excess of the predetermined size but insufficient to cam an additional coupon are stored and then applied to user transaction or payment amounts during the next-subsequent billing period.

Consequently, there is a need in the art for a method of splitting the costs of a transaction among multiple payment sources.

There is a further need in the art for a system that provides the means to split the costs of a transaction among multiple payment sources.

### SUMMARY OF THE INVENTION

In a preferred embodiment of the invention, what is provided is a method for splitting the cost of a consumer purchase among multiple payment sources comprising: prompting the consumer at the time of purchase to designate if the cost will be split among multiple payment sources; determining the number of the sources that will be used to pay for the cost; receiving information necessary about the sources for completing the sales transaction; processing the information from the sources to pay for cost of the purchase; and, notifying consumer of the status of the transaction.

In an alternate embodiment, what is provided is a method for splitting the cost of a consumer purchase among multiple payment sources in a distributed system comprising: prompting the consumer at the time of purchase to designate if the cost will be split among multiple payment sources; determining the number of the sources that will be used to pay for the cost; receiving information necessary for validation of the sources; transmitting the information for processing to an online payment verification service; receiving validation status of the sources; and, processing the validation status, whereby if validation was successful, the consumer is allowed to finalize the transaction, however if the validation was unsuccessful for at least one the source then the consumer is presented with a number of options that would allow the consumer to successfully conclude the transaction.

In a still further alternate embodiment, what is provided is a distributed system for splitting the cost of a consumer purchase among multiple payment sources comprising: a merchant website, whereby the website is in operative communication with a global computer network and offers goods to consumers via the network; application software, whereby the software is integrated with the website, and where the software is responsible for coordinating the receipt and processing of certain payment information from the consumer; an online payment service, whereby the service is in communication with the website and the software installed on the website via the network, and where the service is responsible for requesting payment authorization for the consumer; and, a financial institution, whereby the institution maintains accounts of the consumers and can transmit to the service an approval or disapproval of a payment authorization request.

In a still further alternate embodiment, what is provided is a method for splitting the cost of a consumer purchase among multiple payment sources in a centralized system comprising: prompting the primary consumer at the time of purchase to designate if the cost will be split among multiple payment sources; determining the number of the sources that will be used to pay for the cost; transmitting to secondary consumers details of the purchase, whereby information required for successful conclusion of the purchase is solicited from the secondary consumers; receiving information necessary for validation of the sources from primary consumer at purchase initiation and secondary consumers through the solicitation; transmitting the information for processing to an online payment verification service; receiving validation status of the sources; and, processing the validation status, whereby if validation was successful, the consumers are allowed to finalize the transaction, however if the validation was unsuccessful for at least one the source then the consumers are presented with a number of options that would allow the consumer to successfully conclude the transaction.

In a still further alternate embodiment, what is provided is a centralized system for splitting the cost of a consumer purchase among multiple payment sources comprising: a merchant website, whereby the website is in operative communication with a global computer network and offers goods to consumers via the network; a central database/server complex, whereby the complex is in communication with the website and the consumers via the network, and where the complex is responsible for coordinating the receipt, storage and processing of certain payment information from the consumers; application software, whereby the software is installed on the complex and is responsible for controlling the operation of the complex and the coordination, storage and receipt of the payment information from consumers, whereby the information is eventually transmitted via the merchant website for validation and authorization; an online payment service, whereby the service is in communication with the website via the network, and where the service is responsible for requesting validation and payment authorization on behalf of the consumers; and, a financial institution, whereby the institution maintains accounts of the consumers and can transmit to the service validation and an approval or disapproval of a payment authorization request.

In a still further alternate embodiment, what is provided is a method for splitting the cost of a consumer purchase among multiple payment sources at a traditional retail site comprising: prompting the consumer at the time of purchase to designate if the cost will be split among multiple payment sources; determining the number of the sources that will be used to pay for the cost; swiping the sources at the retail site for validation of the sources; transmitting the information for processing to a financial institution capable of authorizing payment on behalf of the consumer; receiving authorization status of the sources; and, processing the authorization status, whereby if authorization was successful, the consumer is allowed to finalize the transaction, however if the authorization was unsuccessful for at least one the source then the consumer is presented with a number of options that would allow the consumer to successfully conclude the transaction.

In a still further alternate embodiment, what is provided is a system for splitting the cost of a consumer purchase among multiple payment sources comprising: a retail store, whereby the store offers goods or services to consumers via the store; application software, whereby the software is integrated with the store's card swipe mechanism, and where the software is responsible for coordinating the receipt and processing of certain payment information received from the consumers payment sources; and, a financial institution, whereby the institution maintains accounts of the consumers and can transmit to the service an approval or disapproval of a payment authorization request.

In a still further alternate embodiment, what is provided is a system for splitting the cost of a consumer purchase among multiple payment sources comprising: a merchant website, whereby the website is in operative communication with a global computer network and offers goods to consumers via the network; a central database/server complex, whereby the complex is in communication with the website and the consumers via the network, and where the complex is responsible for coordinating the receipt, storage and processing of certain payment information from the consumers; application software, whereby the software is installed on the complex and is responsible for controlling the operation of the complex and the coordination, storage and receipt of the payment information from consumers, whereby the information is eventually transmitted via the merchant website for validation and authorization; an online payment service, whereby the service is in communication with the website via the network, and where the service is responsible for requesting payment authorization for the consumers; and, a financial institution, whereby the institution maintains accounts of the consumers and can transmit to the service an approval or disapproval of a payment authorization request.

Accordingly, it is an object of the present invention to a method of splitting the costs of a transaction among multiple payment sources.

It is another object of the present invention to provide a system that provides the means to split the costs of a transaction among multiple payment sources.

### BRIEF DESCRIPTION OF THE DRAWINGS

FIG. 1 is a partial process flow chart of a preferred embodiment of the Distributed Model according to the invention.

FIG. 2 is a partial process flow chart of a preferred embodiment of the Distributed Model according to the invention.

FIG. 3 is an illustration of Screen 1 of the user interface in the Distributed Model according to the invention.

FIG. 4 is an illustration of Screen 2 of the user interface in the Distributed Model according to the invention.

FIG. 5 is an illustration of Screen 3 of the user interface in the Distributed Model according to the invention.

FIG. 6 is an illustration of Screen 4 of the user interface in the Distributed Model according to the invention.

FIG. 7 is an illustration of Screen 5 of the user interface in the Distributed Model according to the invention.

FIG. 8 is an illustration of Screen 6 of the user interface in the Distributed Model according to the invention.

FIG. 9 is an illustration of Screen 7 of the user interface in the Distributed Model according to the invention.

FIG. 10 is an illustration of Screen 8 of the user interface in the Distributed Model according to the invention.

FIG. 11 is an illustration of Screen 9 of the user interface in the Distributed Model according to the invention.

FIG. 12 is an illustration of Screen 10 of the user interface in the Distributed Model according to the invention.

FIG. 13 is a partial process flow chart of a preferred embodiment of the Centralized Model according to the invention.

FIG. 14 is a partial process flow chart of a preferred embodiment of the Centralized Model according to the invention.

FIG. 15 is a partial process flow chart of a preferred embodiment of the Centralized Model according to the invention.

FIG. 16 is an illustration of Screen 1 of the user interface in the Centralized Model according to the invention.

FIG. 17 is an illustration of Screen 2 of the user interface in the Centralized Model according to the invention.

FIG. 18 is an illustration of Screen 3 of the user interface in the Centralized Model according to the invention.

FIG. 19 is an illustration of Screen 4 of the user interface in the Centralized Model according to the invention.

FIG. 20 is an illustration of Screen 5 of the user interface in the Centralized Model according to the invention.

FIG. 21 is an illustration of Screen 6 of the user interface in the Centralized Model according to the invention.

FIG. 22 is an illustration of Screen 7 of the user interface in the Centralized Model according to the invention.

FIG. 23 is an illustration of Screen 8 of the user interface in the Centralized Model according to the invention.

FIG. 24 is a view demonstrating the relationship between vital components of the Distributed Model.

FIG. 25 is a view demonstrating the relationship between vital components of the Centralized Model.

FIG. 26 is a partial process flow chart of a preferred embodiment of the Offline Model according to the invention.

FIG. 27 is a partial process flow chart of a preferred embodiment of the Offline Model according to the invention.

### DETAILED DESCRIPTION OF THE PREFERRED EMBODIMENT

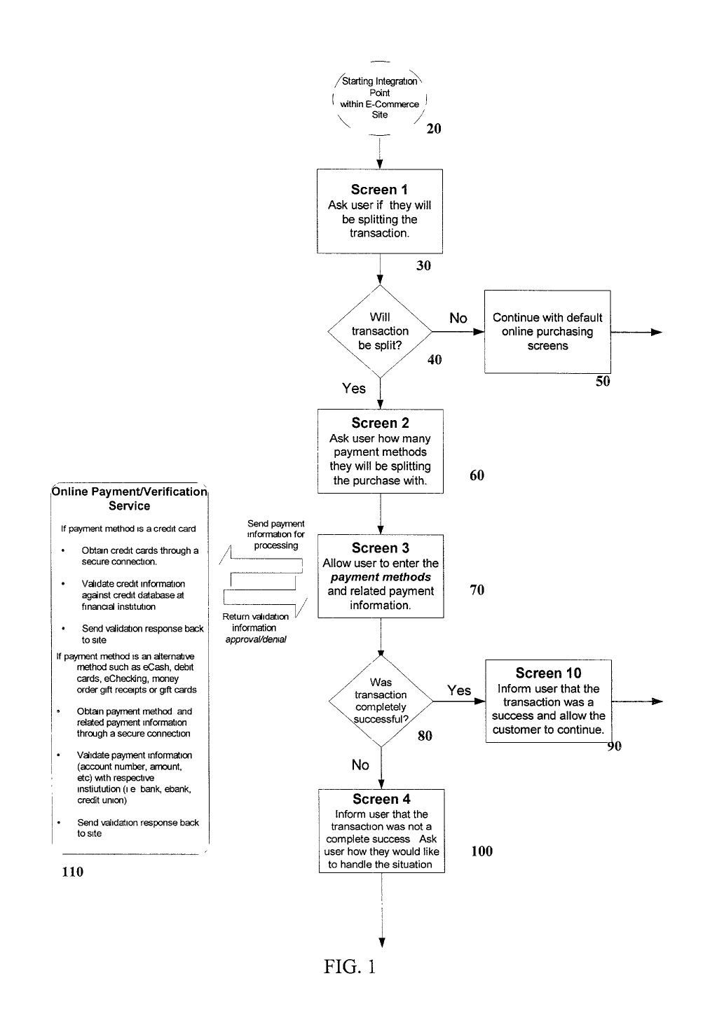

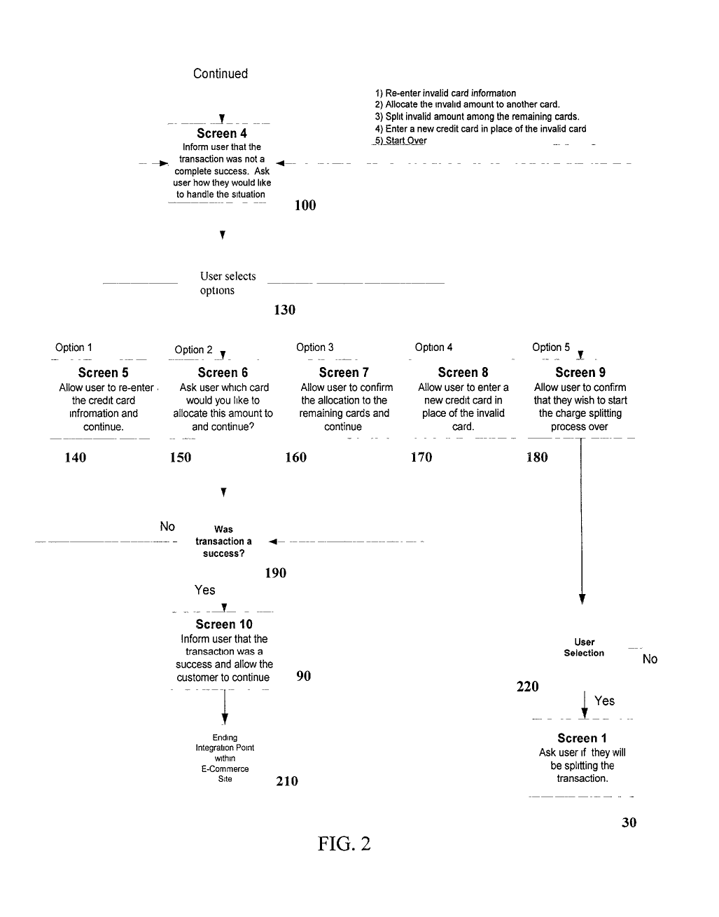

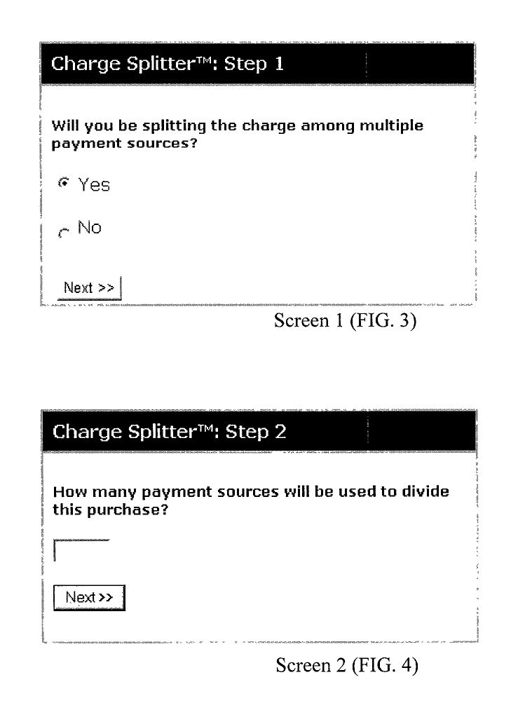

Referring initially to FIGS. 1 and 2 of the drawings, in which like numerals indicate like elements throughout the several views, in a preferred embodiment, the Distributed Model Charge Splitter Application within the Merchant web site 4 is diagrammed using a flow chart. In order to insure that the application is intuitive and user-friendly, the application is set up as a wizard. The application walks the user through a series of questions using a series of basic screens, FIGS. 3-12. The application will gather the customer's responses from screen to screen and direct the customer accordingly to the next screen. To store the information from screen to screen, the application will write the user's responses to hidden fields. Once the application has gathered all of the required information, it will integrate with the online payment service site 110.

As mentioned, there are a variety of online payment services that are in use today. Although they are quite similar, each has a different method for integration. In addition, various disparate technology platforms exist today with are used to run Merchant web sites 4. To address the different online payment service options and the different technology platforms, the application will be developed as a series of separate packages. Each package will address a different combination of payment service/technology platform. In essence, once the business logic has been solidified, it will be implemented as separate downloadable packages. For example, one will be developed for the Microsoft Platform with CyberCash, another one for the UNIX platform with Authorize.Net, and so on and so forth. These packages will include a series of scripted web pages and will be available to download from a web site along with detailed instructions and sample code.

With either the distributed or centralized model, the intent of the Charge Splitter Application is not to replace the current online payment services. Instead, the idea is to leverage the established online payment functionality and provide a more dynamic and functional front-end interface to the existing service. The Charge Splitter Application will be built to integrate into many of the popular online payment services that are in existence today. In order for the application to be fully integrated, the service will have to be flexible and allow for external programs (within the Charge Splitter) to call a variety of online payment functions.

The functions or commands that are necessary for the Charge Splitter to function are as follows:

Real-time payment authorizations

Marking and settling transactions in batches

Returns to customer accounts

Dynamic Authorization without payment capture

Voiding prior transactions

Querying for prior transactions and orders

Access to these functions through code are a critical success factor for the Charge Splitter Application and will therefore make it possible to integrate the Charge Splitter Application with the Online Payment Services. Below is a discussion of some of the major online payment services and how the Charge Splitter Application will integrate with each service.

CyberCash's CashRegister software, is a powerful platform that allows merchants to accept payments over the Internet with minimal client side software. Through remote secure interactions with the CashRegister server, a merchant can easily and effectively process credit cards through the merchant's bank of choice. (CyberCash.com). After researching the software and services CyberCash provides, it has been determined that the flexibility of CyberCash's CashRegister software will allow the Charge Splitter Application to be fully integrated. CyberCash's current release, CashRegister 2.0, now provides the “CyberCash Command Application Programming Interface” (API). This new interface provides merchants and developers with a rich suite of commands that are designed to provide the full suite of functionality for back-end processing. Included in the API are the aforementioned necessary commands.

Authorize.Net offers a server-based transaction processing system that enables businesses to authorize, process, and manage credit card and electronic check transactions in a real-time, online environment from any computer with an Internet connection and a Web browser (Authorizenet.com). WebLink is the service Authorize.Net offers to online merchants. This service has two options: WebLink—Relay Response and WebLink—Direct Response. Utilizing WebLink—Relay Response, when online customers are ready to purchase products or services from a merchant's web site, WebLink—Relay Response captures the necessary information (name, credit card number, etc.) through a standard WebLink transaction page, hosted on an Authorize.Net server.

WebLink—Direct Response on the other hand allows the merchant to set up their own customized secure transaction page (pages in the case of the Charge Splitter Application). Based on discussions with Authorize.Net's development team, if the merchant chooses the route to customize their own secure transaction page and host it on their own secure server through WebLink—Direct Response to capture the necessary credit card information, the integration between the Charge Splitter and WebLink is possible. If, however, the online merchant is leveraging the standard WebLink—Relay Response transaction page hosted on an Authorize.Net server, it will not be possible to integrate with the Charge Splitter Application because the integration points do not exist on the local merchant's E-Commerce server. Based on discussions with Authorize.Net, it is easy to move from the remote transaction model to the local transaction model making it possible to integrate the Charge Splitter Application with any Authorize.Net customer.

Similar to Authorize.Net, Verisign offers two online verification services. The first, Payflow Link, enables merchants to connect their consumers to a secure VeriSign-hosted order form and use it to automate order acceptance, authorization, processing, and the management of transactions. This is accomplished by adding a link to the online merchant's E-Commerce web site (Verisign.com). This service is similar to Authorize.Net's WebLink—Relay Response service where the online merchant uses the payment form provided by the payment service and it is hosted on the payment service's server not the merchant's. Verisign's higher-end service, Payflow Pro offers a seamless payment processing solution. Payflow Pro enables payment processing through the Payflow Pro client software. This software is a small SSL TCP/IP enabled messaging agent that controls communications between your application and the Payflow Platform. Payflow Pro creates a dedicated SSL TCP/IP level communication thread for each transaction between the client and the server (Verisign.com). Based on technical discussions with Verisign, this flexibility allows for the Charge Splitter to be fully integrated.

While CyberCash, Authorize.Net and Verisign are the most dominant and widely used online payment services, the following list includes other online payment services which exist in the marketplace today:

Anacom

AT&T SecureBuy

BlueMoney

CyberSource

ECDirect,

ITransact

Research indicates that these services, while they are not as widely used, have many of the same products/services and it is therefore assumed that they will function in the same manner as CyberCash, Authorize.Net and Verisign/Signio.

Once downloaded, the developer of the Merchant web site 4 will use the instructions and the sample code to integrate the Charge Splitter Application into their online store. They will be replacing the default ‘one-card’ payment screen on their web site with the screens developed for the Charge Splitter Application. Once the package is integrated into the Merchant site 4, the new screens will walk the customer through the screens detailed earlier in this document to initiate and complete the charge splitting process.

Many Merchant web sites in production today are powered by packaged software, such as Microsoft's Site Server-Commerce. Since this is the case, the Charge Splitter Application will have to be integrated into this packaged software. Microsoft's Site Server Commerce Edition, IBM's Net.Commerce server and Oracle's Payment Server come with payment plug-ins. These payment plug-ins are code modules that integrate with the popular online payment services which were discussed. Depending on the Packaged Merchant software and the technology platform the site is running on, a downloadable Charge Splitter Application package may need to be developed to address these particular scenarios.

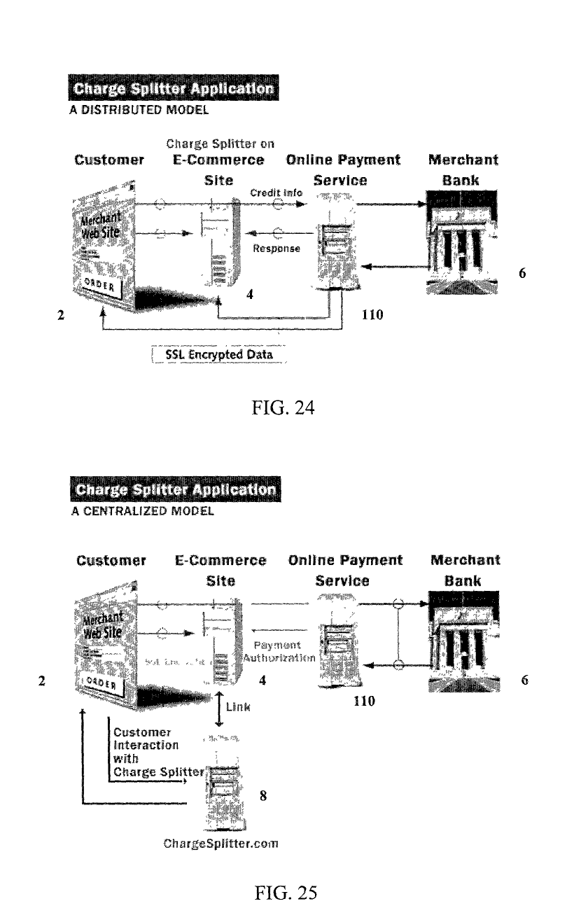

FIG. 24 is a diagram demonstrating the relationship between the various components of the Distributed Model embodiment of the present invention. In the Distributed Model, a customer 2 places an order with the merchant web site 4, which is integrated with the charge splitter software on its server, and is in secure communication with the online payment service 110. The online payment service 110 is in turn capable of credit card verification and validation with various financial institutions 6.

FIG. 3 is an example illustration of the first screen 30 in the charge splitter application flow. This screen 30 is the initial integration point within the Merchant site 4. This screen 30 will be accessed at the point in the Merchant site's 4 checkout process where the customer is required to enter their payment information for their online transaction. Instead of using the default “one credit card” payment screen 50, this screen 30 will be displayed in its place. The main purpose of this screen 30 is to discover whether the user will be splitting 40 the current transaction among multiple payment sources. The screen's interface will consist of a ‘Yes’ and a ‘No’ radio button for user input as well as a ‘Next’ button to submit the user's answer and move to the next screen in the Charge Splitter Application wizard. The interface could utilize other forms of data entry other than radio buttons, such as fill in the blanks, or check boxes. The validation on this screen will consist of testing for a NULL entry. The application will not allow the user to proceed unless they have selected ‘Yes’ or ‘No’. Once the user has submitted their answer to the question, the application will perform some basic business logic in the form of one “If”-“Then” statement to redirect the customer to the next appropriate screen. If the user selects “Yes”, they will be redirected to the Screen 2, FIG. 4. If the user selects “No” they will be redirected back to the default one payment source payment screen 50.

Once the user has decided that their transaction will be split among multiple payment sources, Screen 2 60 will ask the user how many sources will be used to split this purchase, Screen 2 is illustrated in FIG. 4. The Charge Splitter Application will be built to accept an unlimited number of sources (to an extent—see validation) as opposed to having a limit to the number of sources that can be used per transaction. This screen 60 will have one input device—a text box to enter the number sources that will be used for the current transaction. The validation on this screen 60 will consist of two components. Even though the user can enter an unlimited number of payment sources, it is recommended to incorporate validation that will limit the input text box to 2 digits. This will force the user to enter a number less than 100. As well, the screen 60 will validate that the value the user entered is a numeric value. Once validated, the application logic behind this screen 60 will accept the value entered by the customer and pass it on to the next screen 70.

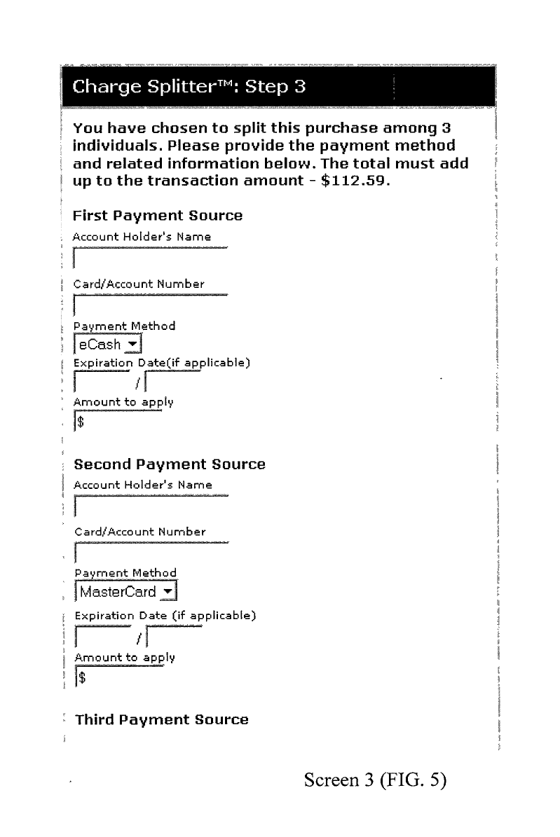

The information that was input into Screen 2 60 will be passed on to Screen 3 70 (Note: the information transmission mechanism from screen to screen will be dependent upon the web programming language utilized in the online merchant's web site which will be discussed later in this document). Screen 3 is depicted in FIG. 5. Based on the number entered previously, this screen 70 will dynamically display a set of payment source input boxes for ‘Cardholder Name’, ‘Credit Card Number’, and ‘Credit Card Expiration Date’. As well, it will display a drop down list box for the ‘Credit Card Type’ and the dollar amount to apply to this source. The validation on this screen 70 is extremely important. The purpose of validation on this screen 70 is to disallow invalid payment source information to be sent to the online payment service 110. Besides checking blank entries for all fields on the screen 70, it will also perform the following standard payment source validation before the source information is sent for verification:

Validation of a non-numeric ‘Cardholder Name’

Validation of the number of digits in the ‘Credit Card Number’field based on the ‘Credit Card Type’ selected

Validation of the ‘Credit Card Expiration Date’ based on the current date

Adding up the dollar amounts allocated to each source to make sure it adds up to the total amount of the purchase.

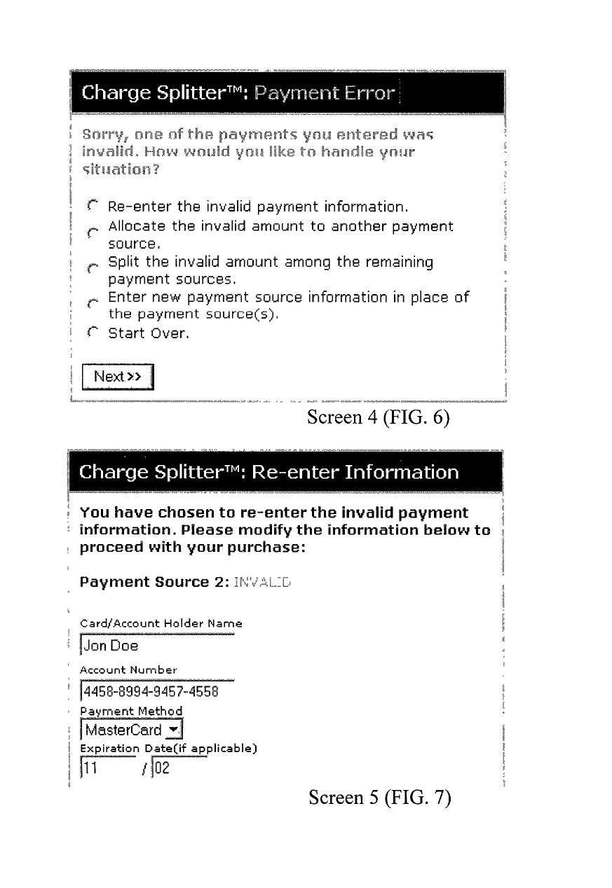

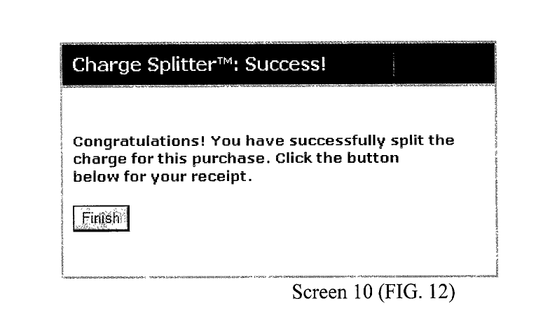

Once validated, the application logic within this screen 70 will send the payment source information in a batch for authentication (Authentication is the process by which the online payment service verifies the authenticity of a payment source. It does not, however, capture the payment amount at that time or submit a payment for processing). This screen 70 is the integration point to the online payment system. Besides sending the information to the online payment service 110, application business logic will be built into the screen 70 that will understand the response from the online payment service 110. The Charge Splitter Application will send the payment source information to the online payment vendor to be processed. Based on the response from the credit verification service, the application will be programmed to address any combination of responses. If the payment source verification service sends back a valid response for all of the payment sources involved in the transaction, it will direct the customer to the standard order receipt page for that Merchant storefront 4. If the payment source verification service sends back an invalid response for one or more of the sources involved in the transaction, the application will be programmed to respond accordingly by asking the user how to handle the situation. Once again, ‘If’-‘Then’ statement will be utilized. If the authentication is completely successful (i.e. all of the payment sources are approved), the application business logic will redirect the user to Screen 10 90, illustrated in FIG. 12, to inform the user that the transaction was a success and to click “Finish” to finalize the purchase and receive a payment receipt. If any of the sources failed authentication, then the customer is redirected to Screen 4 100, illustrated in FIG. 6, to inform the user that transaction was not a complete success.

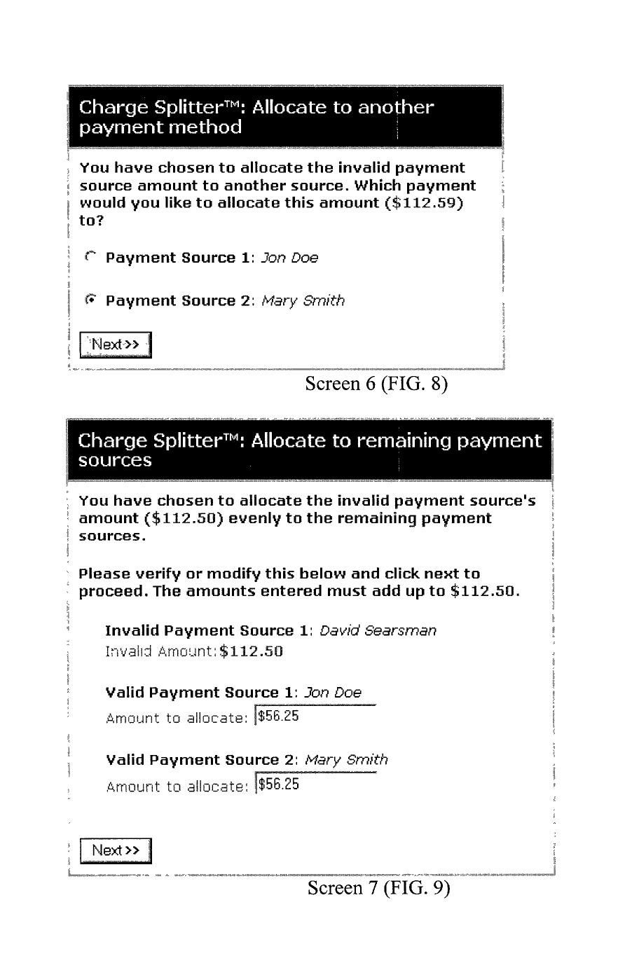

Referring now to FIG. 6 and 100 of FIG. 1, the information has been sent to the online payment service 110 and at least one invalid response was received. The purpose of this screen 100 is to inform the customer that there was a problem and ask the customer how they wish to handle the current situation. This screen 100 will consist of a series of five radio buttons, or five different options 130, as input devices. Each radio button will correspond to a particular course of action 140-180 the customer can take to rectify the current situation. Several options will be presented to the customer (i.e. re-enter credit information, allocate invalid source amount to valid sources, etc.). Based on the user's response regarding how to handle the current situation, the Charge Splitter Application will display the appropriate screens to the user and take action accordingly. This dynamic interactive ability of the charge splitter application will be incorporated into the business rules. As discussed, the user will select an option 140-180 and click the ‘Next’ button to continue along the selected path. The validation on this screen will insure that the customer selected a choice before they click the ‘Next’ button. The application business logic will accept the input from the customer and redirect the user to the next appropriate screen. For example, if the customer selects the option to re-enter the invalid payment source's information 140, the customer will be redirected to Screen 5, as illustrated in FIG. 7. If the customer decides to allocate the invalid amount to one of the valid sources 150, the customer will be redirected to Screen 6, as depicted in FIG. 8. Although it is not shown in the Figures, the application will notify the customer which source or sources are invalid.

Referring to FIG. 7, the customer has decided at this point to re-enter the source information that was not authorized because it was invalid for one reason or another. This screen 140 will be designed to appear with the previous information already filled in. This is done for two reasons. First, it is an added convenience to modify the information as opposed to having to re-enter everything from scratch. Second, this will give the customer the ability to view the information they previously submitted and compare it to what they are about to change it with. The validation on this screen 140 will be the same standard payment source validation that was used on Screen 370 (i.e. Validation of Cardholder Name, Number, Expiration Date, etc.). Once again, this will insure that invalid information is not sent to the online payment service 110 for verification/approval. The application business logic will accept the input from the customer and organize it so it is in the format required by the online payment service 110. Once the information is organized and formatted appropriately, the application business logic will send the information utilizing the appropriate authorization command designated by the online payment service 110.

Referring to FIG. 8, the customer has decided to allocate the invalid source's amount to another valid source. The purpose of this screen 150 is to list the sources that participated in this transaction that were approved by the online payment service 110. The input from the customer will be received when the user selects the radio button that corresponds with the source information they wish to use and clicks the ‘Next’ button. The validation on this screen 15O will simply make sure the customer has selected one of the choices before proceeding. The application business logic will accept the customer's response and send the other authorization request to the online payment service 110 with the invalid amount. Based on the success/failure of the transaction, the application business logic will do one of two things:

1) Authorization Failure: redirect the user back to Screen 4 100 to see how they would like to handle the situation

2) Authorization Success: redirect the customer to Screen 10 90, depicted in FIG. 12, to inform the customer that the transaction was authorized and that the entire charge splitting process is complete.

Referring to FIG. 9, the customer has decided to allocate the invalid source's amount to the remaining valid sources. This screen 160 will allow the user to view the invalid source. Initially, it will evenly distribute the invalid amount evenly among the remaining sources (by default). It will, however, allow the customer to modify the amounts to allow ultimate flexibility in splitting the charge. The validation on this screen 160 will make sure the breakdown of the dollar amounts entered by the customer adds up to the total dollar amount of the invalid payment source(s). It will also check for zero values and values that are not a valid currency. Once validated, the application business logic will accept the individual dollar amounts identified by the customer. It will then format the payment source information appropriately for the online payment service 110. A batch authorization process will be used to submit payment source information to the online payment service 110. Once correctly formatted, the application business logic will call the appropriate command to submit the payment batch for authorization. The application business logic will also receive the response from the online payment service 110 and redirect the user accordingly based on authorization approval or denial.

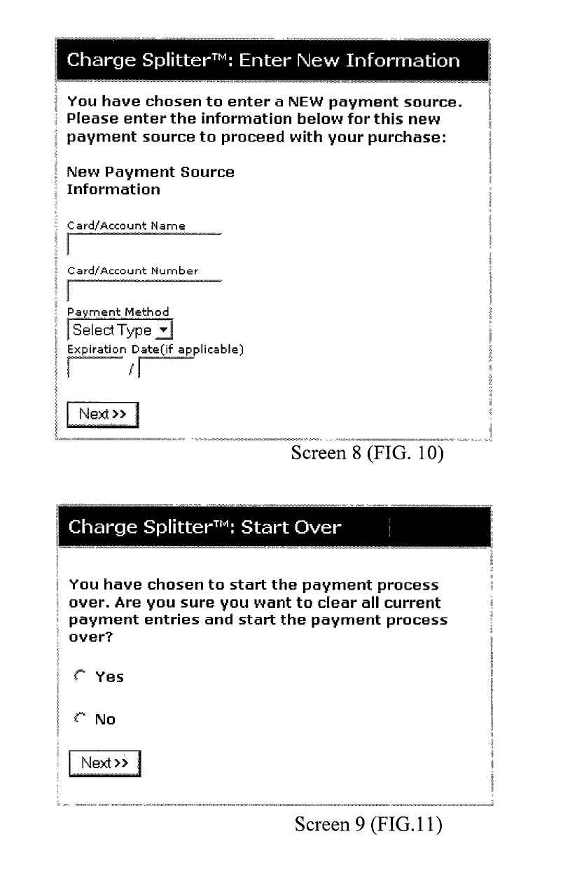

Referring to FIG. 10, the customer has decided to enter a new payment source to replace the payment source that was invalid. This screen 170 will allow for the input of this new payment source. The validation on this screen 170 will be the same standard payment source validation that was used on Screen 3 70 (i.e. Validation of Cardholder Name, Number, Expiration Date, etc.). Once again, this will insure that invalid information is not sent to the online payment service 110 for verification/approval. The application business logic will accept the input from the customer and organize it so it is in the format required by the online payment service 110. Once the information is organized and formatted appropriately, the application business logic will send the information utilizing the appropriate authorization command designated by the online payment service 110.

Referring to FIG. 11, the customer has decided start the charge splitter process over. This screen 180 will act as a confirmation to make sure the customer really wants to clear all of the previous payment source information entered and start the process over from the beginning. It will contain two radio buttons for choices and a ‘Next’ button to submit their confirmation. The validation on this screen 180 will simply make sure the customer has selected one of the choices before proceeding. The application business logic will accept the input from the customer and redirect the user accordingly. If the customer confirms that they want to start the process over, the application business logic will clear all previous information and redirect the customer to Screen 1 30. If the customer selects no, they will be redirected to Screen 4 100.

Referring to FIG. 12, the customer's charge splitting process has been a success. This means that all credit information has been authorizing, approved, and charged according to the customer's requests. The purpose of this screen 90 is to communicate this to the user and allow them to continue with the overall transaction. At this point in the process the user will most likely be directed to an order receipt page to complete the online transaction. There is no validation on this screen 90. The only application logic on this screen 90 will be to redirect the user to the appropriate order receipt page generated by the Merchant web site 4.

In an alternate embodiment, consumers can utilize the Charge Splitter Application through a platform integrated into a centralized (as opposed to the Distributed Model discussed above) Charge Splitter web and database server. Once again, the application is set up as a wizard. It will gather the customer's responses from screen to screen and direct the customer accordingly to the next screen. Instead of collecting the required payment source information for the purchase, the wizard will collect the email addresses of the other individuals involved in the purchase. The Charge Splitter Application will send an email to these people and freeze (store in a database) the transaction information for a predetermined period of time. The email the individuals receive will inform them that they have been selected to participate in an online transaction and will specify the following:

The individual who initiated the transaction.

The Merchant site 4 where the product is being purchased.

The amount of time they have to contribute to the transaction.

The link back to a secure page to enter their credit information.

The Charge Splitter Application will manage the entire process for having each individual to contribute to the purchase. Once all parties involved have made their contribution, the Charge Splitter Application will integrate back to the merchant's Merchant web site to allow the merchant to receive payment and address product fulfillment.

FIG. 25 is a diagram demonstrating the relationship between the various components of the Centralized Model embodiment of the present invention. In the Centralized Model, a customer 2 places an order with the merchant web site 4. The merchant website 4 is linked to the charge splitter server 8 via a global computer network, and is in secure communication with the online payment service 110. The online payment service 110 is capable of payment source verification and validation with various financial institutions 6. The server 8, meanwhile is further responsible for interaction with the customer 2 in order to complete the transaction successfully.

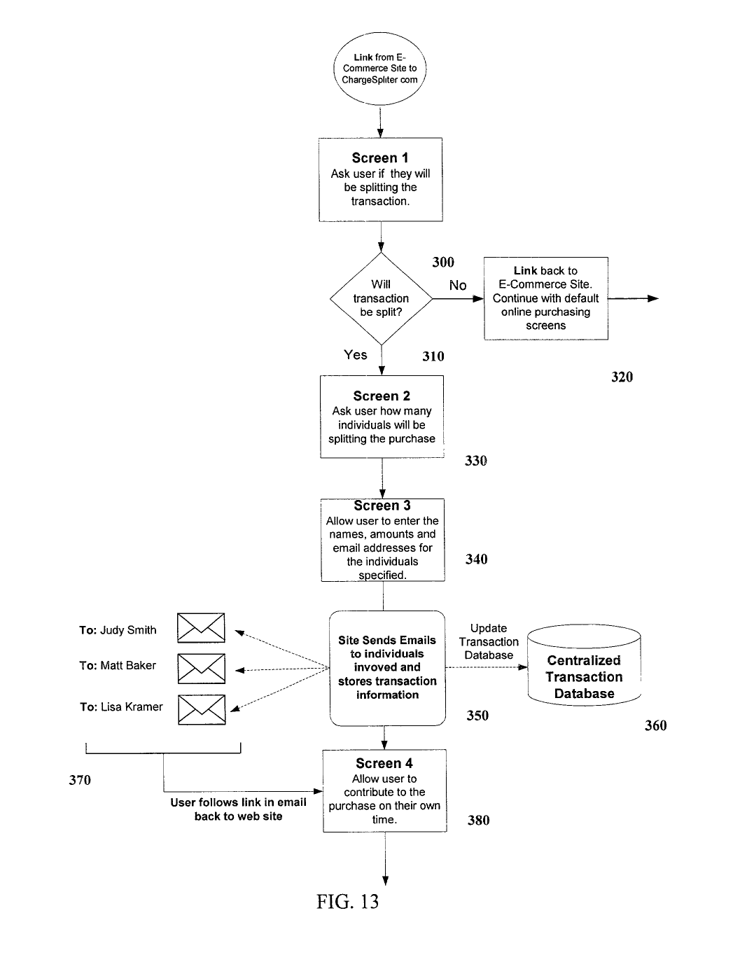

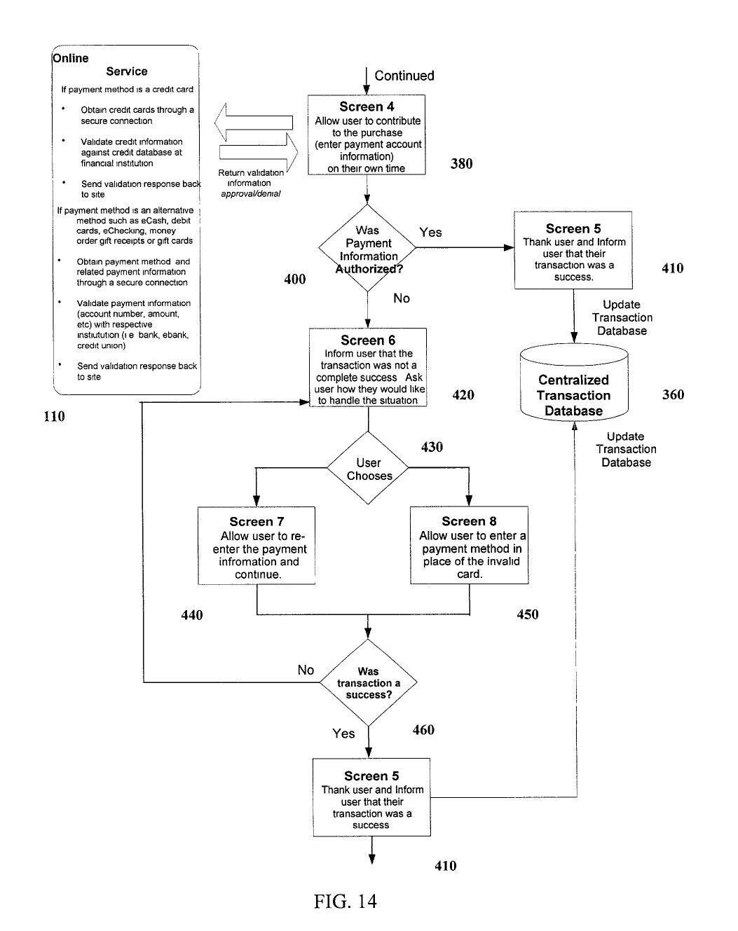

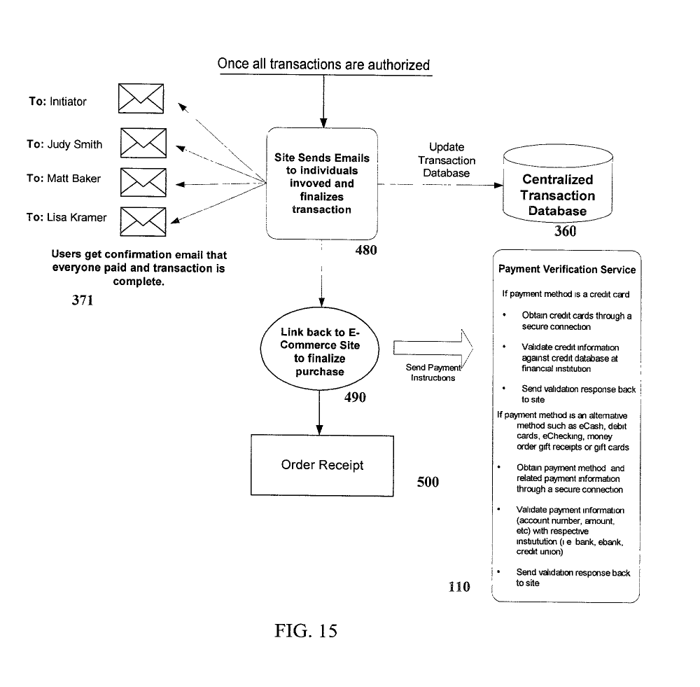

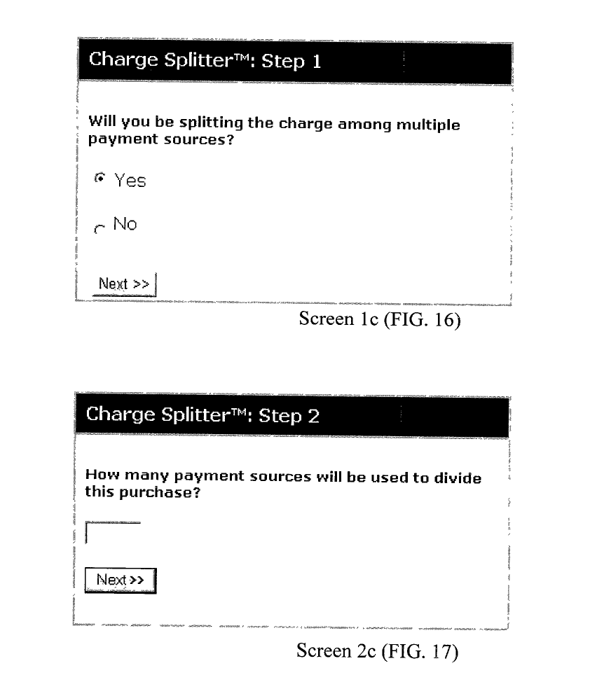

FIGS. 16-23 graphically depict the screens and FIGS. 13-15 depict the flow of information from the beginning to the end of the process. These screens will be served by the centralized web server directly to the customer. The information received from the user will be stored in the centralized database server 360. The pages can be viewed through a frameset with the Merchant site's 4 logo in the top frame and the Charge Splitter functionality appearing in the bottom frame to maintain a seamless integration.

Referring to FIG. 16, this screen 300 is the first screen the customer will see when they link (Although a majority of the functionality for the Charge Splitter Application is moved to an independently managed server for greater control, certain HTML Pages and coding will need to reside on the customer's web server. Regardless of the option chosen, web integration will be required on the customer's server) from the Merchant site 4 to the site where the Charge Splitter Application resides (ChargeSplitter.com). It will be accessed at the point in the Merchant site's 4 checkout process where the customer is required to enter their payment information for their online transaction. Instead of using the default “one payment source” payment screen, this screen 300 will be displayed in its place. The main purpose of this screen 300 is to discover whether the user will be splitting the current transaction among multiple payment sources 310. The screen's 300 interface will consist of a ‘Yes’ and a ‘No’ radio button for user input as well as a ‘Next’ button to submit the user's answer and move to the next screen in the Charge Splitter Application wizard. The validation on this screen 300 will consist of testing for a NULL entry. The application will not allow the user to proceed unless they have selected ‘Yes’ or ‘No’. Once the user has submitted their answer to the question, the application will perform some basic business logic in the form of one “If”-“Then” statement to redirect the customer to the next appropriate screen. If the user selects “Yes”, they will be redirected to the Screen 2c 330, illustrated in FIG. 17. If the user selects “No” they will be redirected back to the default one payment source payment screen 320.

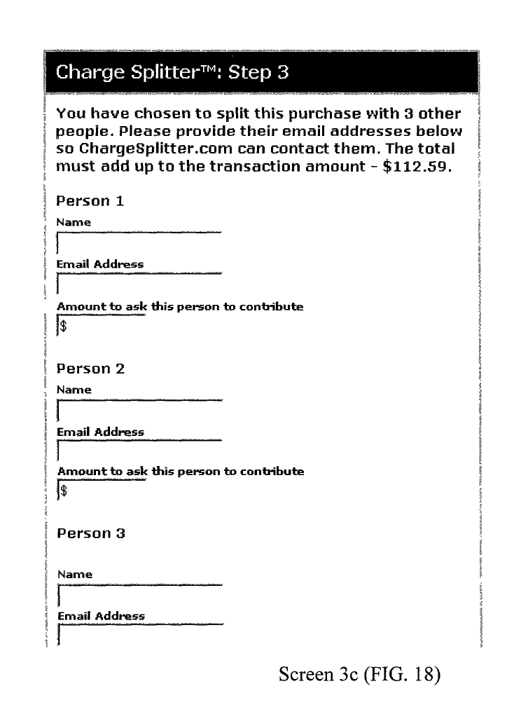

Referring now to FIG. 17, Screen 2c 330 will ask the user how many people will be used to split this purchase. The Charge Splitter Application will be built to accept an unlimited number of people (to an extent—see validation) as opposed to have a limit to the number of people that split a transaction. This screen 330 will have one input device—a text box to enter the number sources that will be used for the current transaction. The validation on this screen 330 will consist of two components. Even though the customer can enter an unlimited number of payment sources, it is recommended to incorporate validation that will limit the input text box to 2 digits. This will force the user to enter a number less than 100 (Additional research should be conducted to assess the feasibility of collected large amount of sources (i.e. >10) for a transaction. As the number of sources increases the profit margins on transactions may decrease). As well, the screen 330 will validate that the value the user entered is a numeric value. Once validated, the application logic behind this screen 330 will accept the value entered by the customer and pass it on to the next screen 340, as depicted in FIG. 18.

Referring now to FIG. 18, Screen 3c 340 will ask the user to enter the names and email addresses of each of the people 370 who will be involved in this transaction. Furthermore, the purchase initiator will specify the amount they want each individual 370 to contribute. The default amount will be an even distribution. An assumption here is that the purchase initiator will include their own information here if they are going to contribute to the purchase as well. The validation on this screen 340 will make sure the user entered a valid name and email address. As well it will make sure none of the amounts are non-numeric or zero. Finally, it will make sure all of the amounts add up to the total amount of the purchase. Once validated, the application logic behind this screen 340 will accept the information the purchase initiator entered and will perform the following functions:

A. Start a new transaction in the centralized transaction database 360. This new transaction will store the following information:

1) The item to be purchased and it's price, there may be additional “shopping cart” information, which is relevant to store in the transaction database (Regardless of the cart information that is captured, it should be in a format generic enough so all customer web sites can easily integrate into the charge splitter application);

2) The Merchant site 4 that this purchase will be made from

3) The names and email addresses and contributory amounts of each of the individuals 370 involved

4) The timestamp of when this transaction was initiated.

B. Send 350 an email to all individuals 370 involved in the transaction.

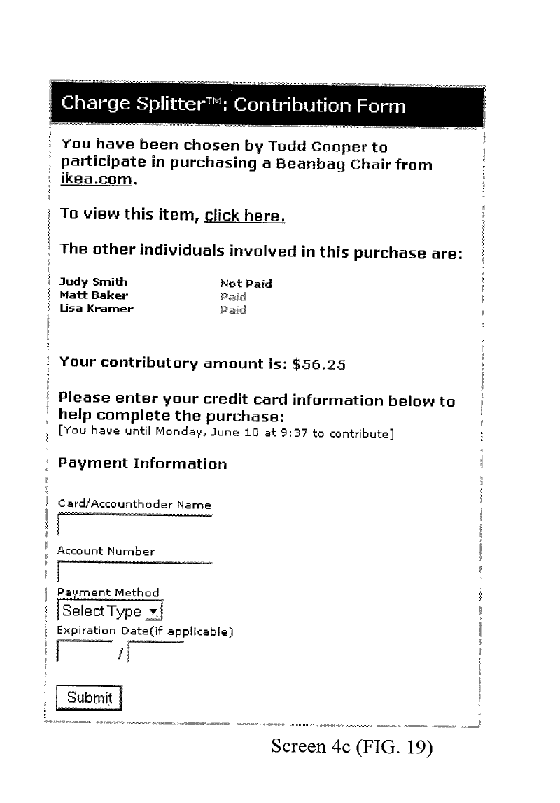

Referring to FIG. 19, which depicts Screen 4c 380, an email will have been previously sent 350 to each potential contributor 370. This email will contain a link to this page 380. The purpose of this page 380 is to inform the user about the purchase, let them know who else is involved in this purchase and how much/when they need to contribute to help complete the overall transaction. The screen 380 will contain the basic payment source validation routines to insure all information is valid before it is sent for processing. Once validated, the application logic will send the credit information to be authorized. It is important to note that the authorization will simply see if this payment source is valid for the amount specified. It will not charge the source at this time. A response will be sent back from the online payment service 110, which will indicate whether the source information is authorized for this purchase. If it is authorized, the application will inform the user and update the transaction database 360 respectively. If it is not authorized it will redirect the user to Screen 6 420, see FIG. 21, to inform user that their transaction was not a complete success and ask user how they would like to handle the situation.

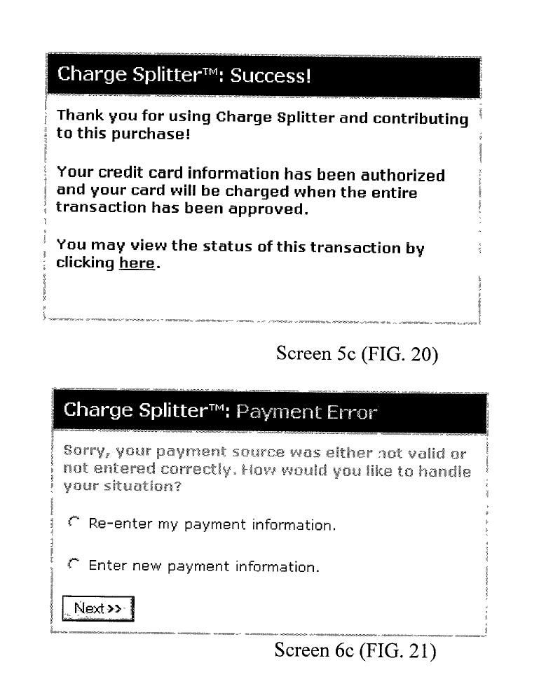

Referring now to FIG. 20, depicted is Screen 5c 410 which is displayed if the contributor charge was a success. The purpose of this screen 410 is to communicate this to the contributor. There is no validation on this screen 410. The only application logic on this screen 410 will be to redirect the user to the appropriate order receipt page generated by the Merchant web site 4. It will also update the centralized transaction database 360 the new approved information. Once all payment sources have been verified, critical purchase and cart information will be sent back to the customer's web site. This is an integration point, which will be further defined to determine a functional and friendly method for the customer to set up their web site to retrieve Charge Splitter Application information. Although this section is termed the centralized model, it is, in essence, a hybrid of a completely centralized model and a distributed model. Defined integration points will require Application Splitter Pages/Code to reside on the customer's web server in order to facilitate the communication between the two pages.

FIG. 21 illustrates Screen 6c 420, which is displayed if the credit information the user entered was not authorized. This screen 420 will inform the user of this and ask how the user wants to handle the situation. They may try to re-enter the information in case there was a typographical error, or they may try a new source. The validation will make sure the user selected 430 one of the choices. Once the user makes their decision, the application business logic will redirect the user accordingly.

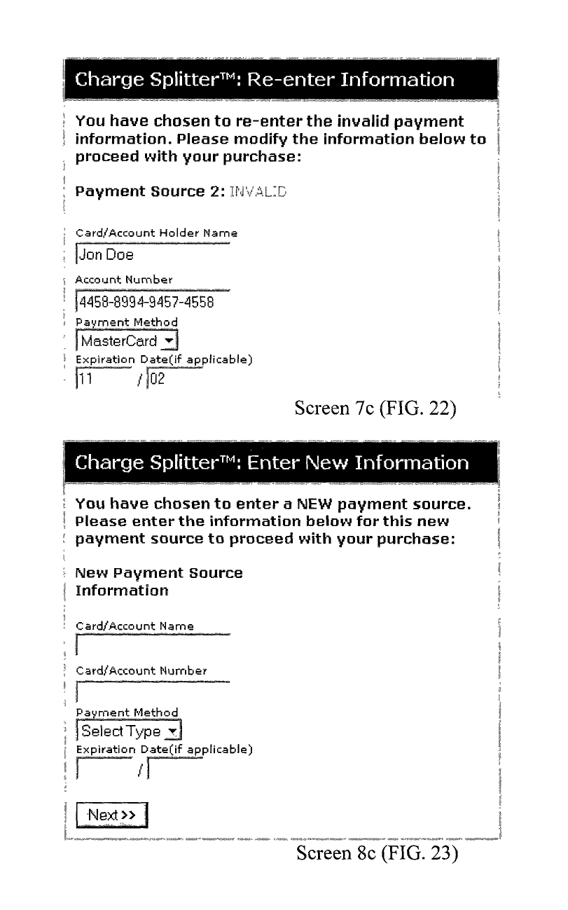

FIG. 22 depicts the scenario where the user has elected to re-enter the source information that was not authorized because it was invalid for one reason or another. Screen 7c 440 will be designed to appear with the pervious information already filled in. This is done for two reasons. First, it is an added convenience to modify the information as opposed to having to re-enter everything from scratch. Second, this will give the contributor the ability to view the information they previously submitted and compare it to previously entered information. The validation on this screen 440 will be the same standard payment source validation that was used on Screen 3c 340 (i.e. Validation of Cardholder Name, Number, Expiration Date, etc.). Once again, this will insure that invalid information is not sent to the online payment service 110 for verification/approval. The application business logic will accept the input from the contributor and organize it in the format required by the online payment service 110. Once the information is organized and formatted appropriately, the application business logic will send the information to be authorized using the appropriate authorization command designated by the online payment service 110.

FIG. 23 depicts the scenario where the user has elected to enter a new payment source to replace the payment source that was invalid. Screen 8c 450 will allow for the input of this new payment source. The validation on this screen 450 will be the same standard payment source validation that was used on Screen 3c 340 (i.e. Validation of Cardholder Name, Number, Expiration Date, etc.). Once again, this will insure that invalid information is not sent to the online payment service for verification/approval. The application business logic will accept the input from the customer and organize it so it is in the format required by the online payment service 110. Once the information is organized and formatted appropriately, the application business logic will send the information utilizing the appropriate authorization command designated by the online payment service 110.

Once all transactions have been authorized at 400 or 460 (this means that each contributor's payment method was authorized for their respective amount), the present invention will perform the following necessary functions:

Send 480 an email to the purchase initiator and each of the contributors 371 to inform them that the transaction is complete and the item will be purchased. An order receipt 500 will be provided to the purchase initiator and each of the contributors 371.

Update the centralized transaction database 360 to close the current transaction 490.

Through a secure connection, send the payment instructions. This will most likely be accomplished by the application sending a series of secure HTTP Post transactions (or one batch transaction) to the Merchant site's 4 online payment service 110 through their existing infrastructure.

Link back to the online merchant's Merchant site 4 to inform the site that there was a purchase. Finally, post (via HTTP Post or XML) the necessary information to the customer's transaction database 360.

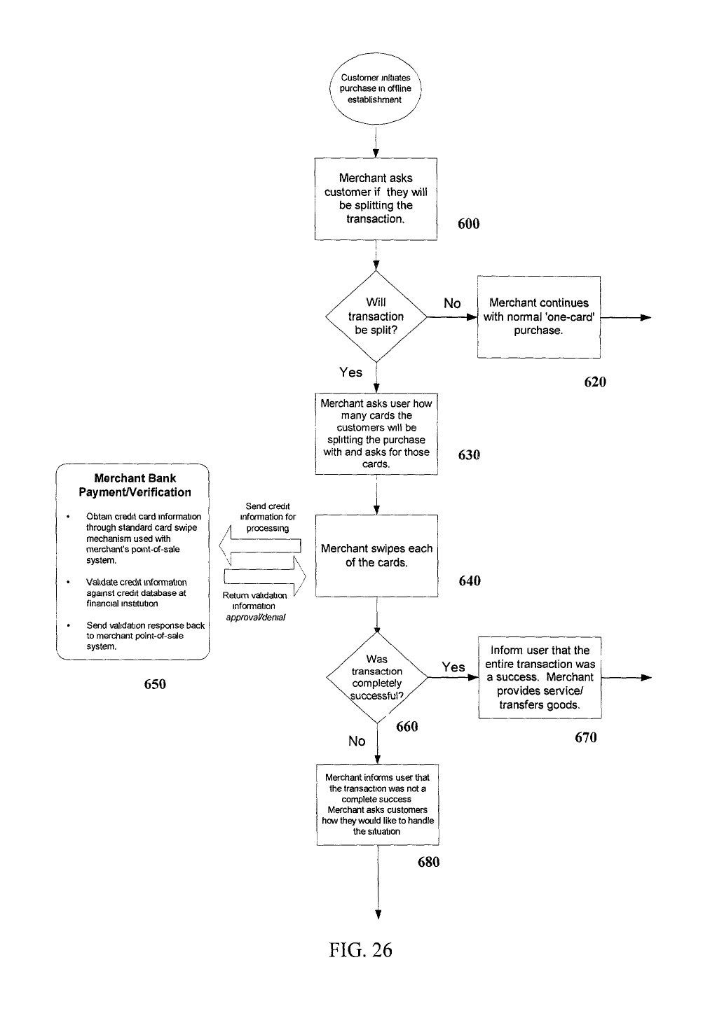

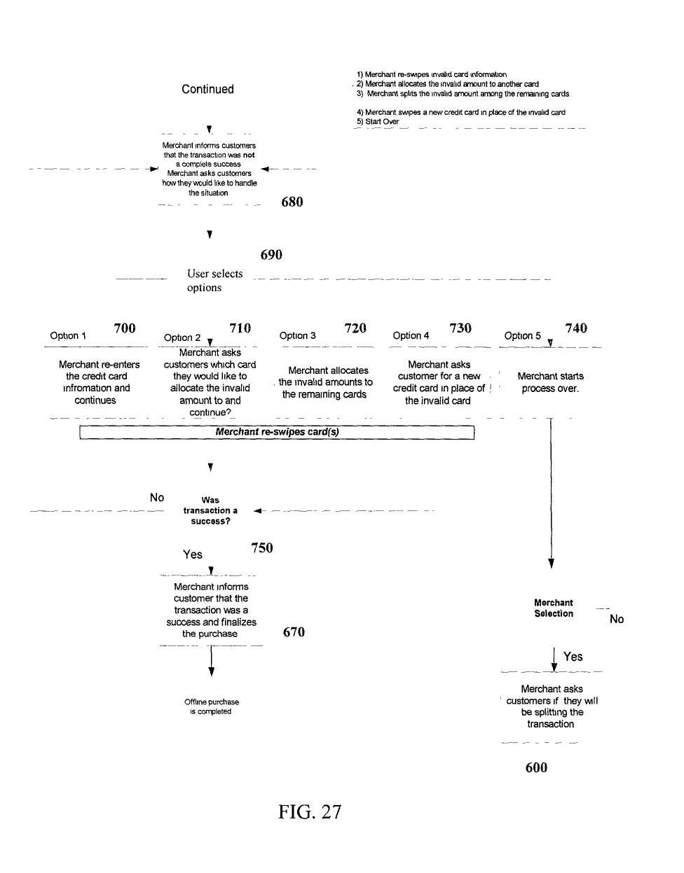

In still further alternate embodiment, the same application business logic and transaction processing model is utilized in an offline environment such as restaurants, retail stores, mail order catalogs, etc. An example of this is as follows: Three college students wish to split the purchase of a couch for their dorm room from a retail store selling furniture. In this case, the merchant would first use the ‘card swipe’ magnetic card reader attached to the point of sale system they currently use today. This point of sale system, however, is not smart enough to split a transaction. The key is that the point of sale application retrieving the card information from the magnetic card reader would need to be enhanced or replaced to utilize the Charge Splitter Application's business logic. The process flow in FIGS. 26 and 27 illustrates this enhanced process. This method is illustrated using credit cards only, however as with the online embodiments, this embodiment could also work with alternate forms of payment.

The Charge Splitter Application must be enhanced or replaced because the charge splitting process must occur before any interaction between the merchant and the merchant bank 650. The application's business logic gathers and organizes the required credit card information either as an enhanced version of the existing point of sale software or in place of this software. This is analogous to how the Charge Splitter Application acts as a front-end to the online payment services 110 (CyberCash, Verisign, etc.) on the Internet. The Charge Splitter Application's business logic will allow for transactions to be split among multiple credit cards through a very similar interface. This application can either be on a system located on the merchant's premises (i.e. leveraging the Distributed Model) or it will be served through an Internet connection to a terminal/browser on the merchant's premises (i.e. leveraging the Centralized Model). Either way, the merchant is able to utilize the predetermined business logic that allows transactions to be split. The critical success factor in the offline world is the integration of the Charge Splitter Application with the existing point of sale software. Once this is achieved, merchants anywhere can split their customers' transactions.

One main difference between the online model and the offline model is who is using the Charge Splitter Application. On the Internet, it is the Internet web site user who is making the purchase. In the offline world, the merchant is the direct user and acts as a proxy for the customer, the indirect user. The application walks the merchant through the same series of questions using the same series of basic screens and application business logic.

The application gathers the merchant's responses from screen to screen and directs the merchant accordingly to the next screen. The enhanced offline process begins by the merchant determining if the cost of the sale will be split 600. If the transaction will not be split, then the merchant will continue with the standard “one card” purchase 620. If the transaction is to be a split purchase, then the merchant will ask the customer how many cards will be used to split the purchase 630. Once the merchant swipes the cards 640, the verification and validation will be performed by the customers' financial institution(s) 650. A successful transaction query 660 is run, and if successful the transaction is completed 670. If merchant bank 650 sends back an invalid response for one or more of the cards involved in the transaction, the application will be programmed to respond accordingly by asking the merchant how to handle the situation. Several options will be presented 690 to the merchant (i.e. Re-enter credit information, allocate invalid card amount to valid cards, etc.). Based on the merchant's response regarding how to handle the current situation, the Charge Splitter Application will display the appropriate screens to the merchant to act accordingly.

The first option presented would be to re-enter the credit card information 700. The second option would consist of the merchant asking the customers which card they would like to allocate the invalid amount to 710. The third option 720 involves the merchant allocating the invalid amount over the remaining valid cards, as opposed to just one card as with second option 710. Replacing the invalid credit card with a new one constitutes the fourth option 730 and restarting the whole payment process over 600 represents the fifth option. After performing one of the first four options 700-730, an unsuccessful transaction return the merchant to the option screen 680. If the transaction is successfully concluded 670 after performing one of the options 700-730 then the purchase is finalized.

A major difference between the online and offline scenario is that instead of having to manually type in all of the credit card information, the merchant has the ability to swipe the cards with the same magnetic reader they normally would use. This makes the process seamless and user-friendly.

The expansion of the Charge Splitter Application into offline markets is a logical progression. While the exponential growth of online transactions will continue to proliferate, credit card transactions in the offline world will undoubtedly continue. The sheer number of existing point of sale systems in use today alone is evidence of how large this opportunity is. Further, traditional merchants and sales transactions already involve a rudimentary form of online activity. Most credit card approvals today are performed in this fashion:

Merchant runs credit card through the point of sale unit. The amount of the sale is either hand-entered or transmitted by the cash register. Merchant transmits the credit card data and sales amount with a request for authorization of the sale to their acquiring bank.

Point of sale units are usually set to request authorization at the time of sale, and then actually capture the sales draft at a later time.

The acquiring bank that processes the transaction, routes the authorization request to the card-issuing bank. The credit card number identifies type of card, issuing bank, and the cardholder's account. If the cardholder has enough credit in their account to cover the sale, the issuing bank authorizes the transaction and generates an authorization code. This code is sent back to the acquiring bank.

The issuing bank puts a hold on the cardholder's account for the amount of the sale. Note that the cardholder's account has not been actually charged yet.

The acquiring bank processing the transaction, and then sends the approval or denial code to the merchant's point of sale unit. Each point of sale device has a separate terminal ID for credit card processors to be able to route data back to that particular unit. A sale draft, or slip, is printed out by the point of sale unit or cash register. The merchant asks the buyer to sign the sale draft, which obligates them to reimburse the card-issuing bank for the amount of the sale.

In “offline” transactions in the future, the standard modem using a telephone line to transmit information from acquiring bank, to issuing bank, etc. may be replaced with a model incorporating use of the Internet, as opposed to the process described above. In this manner, even traditional retail transactions will incorporate some aspects of an online Internet transaction. The combined approach into online and offline markets is what makes the instant invention truly universal.

Accordingly, it will be understood that the preferred embodiment of the present invention has been disclosed by way of example and that other modifications and alterations may occur to those skilled in the art without departing from the scope and spirit of the appended claims.

What is claimed is:

1. A method for splitting the cost of a consumer purchase among multiple payment sources comprising:
prompting the consumer at the time of purchase to designate if the cost will be split among multiple payment sources;
determining the number of said sources that will be used to pay for said cost;
receiving information necessary about said sources for completing the sales transaction;
processing said information from said sources to pay for cost of said purchase; and, notifying consumer of the status of said transaction.

2. The method of claim 1 wherein notifying further includes notifying said consumer that said sales transaction has been successfully concluded.

3. The method of claim 1, wherein notifying further includes notifying said consumer that said sales transaction has not been successfully concluded due to a failure to process at least one said payment source.

4. The method of claim 3, whereby said consumer is presented with options for proceeding towards successful conclusion of said sales transaction.

5. The method of claim 4, wherein consumer selects said option from the group consisting of: re-entering payment source information for the source that was not processed, allocating the entire cost to one payment source, allocating the entire cost among the sources that were successfully processed, replacing the source that was not processed with a substitute source, and restarting the payment portion of said transaction.

6. A method for splitting the cost of a consumer purchase
among multiple payment sources in a distributed system comprising:
prompting the consumer at the time of purchase to designate if the cost will be split among multiple payment sources;
determining the number of said sources that will be used to pay for said cost;
receiving information necessary for validation of said sources, transmitting said information for processing to at least one online payment verification service;
receiving validation status of said sources; and,
processing said validation status, whereby if validation was successful, said consumer is allowed to finalize the transaction, however if the validation was unsuccessful for at least one said source then said consumer is presented with a number of options that would allow said consumer to successfully conclude said transaction.

7. The method of claim 6, wherein multiple payment sources comprise at least one of the following: cash, credit cards, debit cards, eCash, eChecking, gift certificates, gift cards or money order.

8. A distributed system for splitting the cost of a consumer purchase among multiple payment sources comprising:
a merchant website, whereby said website is in operative communication with a global computer network and offers goods or services to consumers via said network;
application software, whereby said software is integrated with said website, and where said software is responsible for coordinating the receipt and processing of certain payment information from said consumer;
at least one online payment service, whereby said service is in communication with said website and said software installed on said website via said network, and where said service is responsible for requesting payment authorization for said consumer; and,
at least one financial institution, whereby said institution maintains accounts of said consumers and can transmit to said service an approval or disapproval of a payment authorization request.

9. The system of claim 8 whereby said application software includes version control functionality, wherein said software resident on said retailers' servers can be updated from a centralized system server.

10. The system of claim 8 whereby said application software includes support functionality, wherein said software resident on said retailers' servers provides help and technical support to said retailers at the retailers' site.

11. A method for splitting the cost of a consumer purchase among multiple payment sources in a centralized system comprising:
prompting the primary consumer at the time of purchase to designate if the cost will be split among multiple payment sources;
determining the number of said sources that will be used to pay for said cost;
transmitting to secondary consumers details of said purchase, whereby information required for successful conclusion of said purchase is solicited from said secondary consumers;
receiving information necessary for validation of said sources from primary consumer at purchase initiation and secondary consumers through said solicitation;
transmitting said information for processing to at least one online payment verification service;
receiving validation status of said sources; and, processing said validation status, whereby if validation was successful, said consumers are allowed to finalize the transaction, however if the validation was unsuccessful for at least one said source then said consumers are presented with a number of options that would allow said consumer to successfully conclude said transaction.

12. The method of claim 11, wherein multiple payment sources comprise at least one of the following: cash, credit cards, debit cards, eCash, eChecking, gift certificates, gift cards or money order.

13. A centralized system for splitting the cost of a consumer purchase among multiple payment sources comprising:
a merchant website, whereby said website is in operative communication with a global computer network and offers goods or services to consumers via said network;
a central database/server complex, whereby said complex is in communication with said website and said consumers via said network, and where said complex is responsible for coordinating the receipt, storage and processing of certain payment information from said consumers;
application software, whereby said software is installed on said complex and is responsible for controlling the operation of said complex and said coordination, storage and receipt of said payment information from consumers, whereby said information is eventually transmitted via said merchant website for validation and authorization;
at least one online payment service, whereby said service is in communication with said website via said network, and where said service is responsible for requesting validation and payment authorization on behalf of said consumers; and,
at least one financial institution, whereby said institution maintains accounts of said consumers and can transmit to said service validation and an approval or disapproval of a payment authorization request.

14. A method for splitting the cost of a consumer purchase among multiple payment sources at a traditional retail site comprising:
prompting the consumer at the time of purchase to designate if the cost will be split among multiple payment sources;
determining the number of said sources that will be used to pay for said cost;
swiping said sources at said retail site for validation of said sources;
transmitting said information for processing to at least one financial institution capable of authorizing payment on behalf of said consumer;
receiving authorization status of said sources; and,
processing said authorization status, whereby if authorization was successful, said consumer is allowed to finalize the transaction, however if the authorization was unsuccessful for at least one said source then said consumer is presented with a number of options that would allow said consumer to successfully conclude said transaction.

15. A system for splitting the cost of a consumer purchase among multiple payment sources comprising:
a retail store, whereby said store offers goods or services to consumers via said store;
application software, whereby said software is integrated with said store's card swipe mechanism, and where said software is responsible for coordinating the receipt and processing of certain payment information received from said consumers payment sources; and,
at least one financial institution, whereby said institution maintains accounts of said consumers and can transmit to said service an approval or disapproval of a payment authorization request.

16. A system for splitting the cost of a consumer purchase among multiple payment sources comprising:
a merchant website, whereby said website is in operative communication with a global computer network and offers goods or services to consumers via said network;
a central database/server complex, whereby said complex is in communication with said website and said consumers via said network, and where said complex is responsible for coordinating the receipt, storage and processing of certain payment information from said consumers;
application software, whereby said software is installed on said complex and is responsible for controlling the operation of said complex and said coordination, storage and receipt of said payment information from consumers, whereby said information is eventually transmitted via said merchant website for validation and authorization;
at least online payment service, whereby said service is in communication with said website via said network, and where said service is responsible for requesting payment authorization for said consumers; and,
at least one financial institution, whereby said institution maintains accounts of said consumers and can transmit to said service an approval or disapproval of a payment authorization request.
